(19) United States
(12) Patent Application Publication
(10) Pub. No.: US 2006/0210685 A1
(43) Pub. Date: Sep. 21, 2006

(54) Adiabatic and aseptic food packaging method and apparatus

(75) Inventor: Chester Savage, Irvine, CA (US)

Correspondence Address: THE WATSON INTELLECTUAL PROPERTY GROUP, PLC, 3133 HIGHLAND DRIVE, SUITE 200, HUDSONVILLE, MI, 49426, US

(73) Assignee: Scholle Corporation

(21) Appl. No.: 11/083,621

(22) Filed: Mar. 17, 2005

(51) Int. Cl. A23B 7/148; B65D 85/00

(52) U.S. Cl. 426/399; 426/106

(57) ABSTRACT

A method of aseptically and adiabatically processing liquid or semi-liquid food product at ambient temperatures so that the food product is transported from one sterile environment (such as a food processing machine), and into another sterile environment (such as a food package) via a food package filling machine head. During operation of the filling machine head, plural surface portions alternate between exposure to ambient and exposure to the food product. The method includes steps such that microbes from the ambient are not allowed to migrate along these alternatingly exposed surfaces. The method includes steps of initially heat sterilizing the alternatingly exposed surfaces at elevated temperature and pressure using culinary steam. Subsequently, an ambient temperature sterilizing barrier is maintained at a selected location along each of the alternatingly exposed surfaces so that migration of microbes along these surfaces and to the food product is prevented. After the initial heat sterilization using culinary steam, substantially adiabatic conditions are achieved for filling packages with the food product. Apparatus for carrying out the method is also disclosed.

### BACKGROUND OF THE INVENTION

1. Field of the Invention

The present invention is in the field of methods and apparatus for aseptically packaging food product into a container or package. More particularly, the present invention relates to method and apparatus for adiabatically packaging food into a flexible plastic bag under aseptic conditions. Still more particularly, this invention relates to an apparatus and method which initially employs culinary steam, non-adiabatically, to achieve aseptic conditions preparatory to packaging the food product. And, after the aseptic conditions have been achieved by the initial or preparatory use of culinary steam, thereafter employs a sanitizing fluid at substantially ambient temperature to maintain aseptic conditions for packaging of the food product adiabatically.

2. Related Technology

Heretofore, in order to transport and preserve food it has been necessary to either sterilize both the food and the container in which the food is packaged (i.e., after filling and sealing of the package), or to introduce foreign substances (i.e., chemical preservatives) which will preserve the packaged food from oxidation, or from bacterial growth, or both. Hot filling of containers is a well known alternative. This hot fill process is used both with metal cans and with plastic bag containers as well. In the hot fill process, the temperature of the food product itself (i.e., about 190° F. or higher) is sufficient not only to sterilize the food product, but to also sterilize the container in which the product is packaged.

The prior procedures are expensive in that they are both labor intensive and expensive in terms of materials cost; and even when they are used, in many instances the procedures of the conventional technology do not fully protect the food product from degradation or spoilage. For example, in the case of whole milk or other perishable products, the sale and use of the product must be accomplished within a specific period of time. Otherwise, bacteria remaining in the food product multiply, degrading the product, and preventing its use, so that the entire package of food product is lost. Alternatively food products must be refrigerated to prevent spoilage in the short-term. Further, heat processing in prior art arrangements have resulted, in some instances, in poor quality control. That is, some food products are sensitive to time/temperature considerations in which the quality or palatability of the food product is adversely affected if either too high a temperature, or a combination of too much time and too high a temperature, are exceeded.

In other procedures such as canning, in which the food products are put up in metal containers, which are sterilized after packaging, the cost of the containers is significant and the cost of processing is likewise significant.

In this context of filling a food product into a container, methods and apparatus for using steam to achieve aseptic conditions necessary in the handling of food and food products are well known. For example, U.S. Pat. No. 3,661,398, issued 9 May 1972 is believed to relate to an improved cartridge type or rotary sanitary seal construction, in which steam is used in an internal chamber of the seal to achieve aseptic conditions on surfaces of a rotary shaft part of which is exposed to ambient.

Similarly, U.S. Pat. No. 4,699,297, issued 13 Oct. 1987 is believed to disclose a cylinder construction in which steam is used to displace food product from one location to another. The cylinder is provided with steam passageways so that steam admitted to these passageways is directed to internal surfaces of the cylinder. A portion of the cylinder is thus sterilized. Another U.S. Pat. No. 4,823,988 was issued on a Continuation of the application leading to the '297 patent, and further describes a rotary block type of valving device using steam to achieve aseptic handling conditions for food product. In each case, heat transfer from the sanitizing steam to the food product may present conventional problems and shortcomings.

Further, U.S. Pat. No. 4,458,734 issued 10 Jul. 1984; and U.S. Pat. No. 5,099,895, issued 31 Mar. 1992 are both believed to relate to filling head apparatus and methods for handling a food product aseptically as the food product is introduced into a package. In each instance, steam is used as a sterilizing medium so those surfaces of the filling head exposed to ambient are sterilized. Again, heat transfer from the sterilizing steam to the food product appears to be possible, and would then present conventional problems and shortcomings.

In each conventional technology mentioned above, and in other conventional technologies as well, steam is used as a sterilizing medium so that surfaces and mechanisms of a food handling machine are sterilized before being exposed to food product. That is, surfaces of the machine that may be exposed to ambient air are exposed to steam before food product is exposed to these surfaces. This sterilization of surfaces must be repeatedly or continuously carried out during operation of the machine because of repeated exposures of the machine's surfaces to ambient conditions. This results in a transfer of heat from the culinary steam to the food product.

However, many food products that are handled (i.e., packaged perhaps) though the use of such conventional apparatus, machines, and methods, are subject to deterioration because of exposure to excessive temperatures, or because of a combination of time and temperature exposure. Consequently, both the temperatures and heat flow to a food product (i.e., non-adiabatic conditions) that result from the use of culinary steam as a sterilizing medium are both undesirable.

Further, in conventional apparatus and methods, when a food packaging machine must be stopped even temporarily for any reason, then the food product must be either removed from the machine, or provision must be made for stopping the flow of steam so that the flow of heat to the food product stops. Attempting to remove the food product is not satisfactory because some remnant of the food product remains in the machine and is damaged by the high temperatures and by the time of exposure to these temperatures.

Even the expedient of stopping the flow of sterilizing culinary steam in the temporarily stopped packaging machine has its disadvantages. When the steam flow is stopped, it is generally stopped by closing off the steam exit from the steam passages of the apparatus. This allows steam to continue communicating to the machine, so that steam condenses into sterile water, which fills the steam passages. As soon as the passages fill with condensate, then the heat flow caused by the steam stops and the food product in the processing machine is not longer subjected to the temperatures and heat flow caused by the steam. That is, an adiabatic condition is achieved, but only after some considerable time interval. However, the heated portions of the food handling machinery and the condensing steam (which gives up phase change heat) generally contain more than enough heat to damage or deteriorate the food product stopped in the machine during such a temporary shutdown of the container filling process.

That is, until the steam condenses and the steam passages fill with condensate, the condensing steam provides a substantial heat source, the heat flow from which will subject food product in the machine to undesirably high temperatures or to undesirable time-temperature combinations. Food products thus are frequently deteriorated in conventional processing machines.

### SUMMARY OF THE INVENTION

In view of the deficiencies of the conventional related technology, it is an object of this invention to overcome one or more of these deficiencies.

An object for this invention is to provide a method to package food product under substantially adiabatic and aseptic conditions, from one sterile enclosure which is provided by a food processing machine and into another and portable sterile enclosure (i.e., into a package).

A further object of this invention is to provide a food processing method in which steam is used as a sterilizing fluid to initially sterilize a surface exposed to ambient, and in which subsequently, a sanitizing fluid at substantially ambient temperature is used to maintain sterility of the surface.

More particularly, the present invention provides arrangements wherein a food product can be pre-sterilized and handled in bulk. Further procedures in accordance with the present invention permit the food product to be pre-sterilized under carefully controlled conditions and then transferred and filled under sterile and substantially adiabatic conditions.

Still another object for this invention is to provide an apparatus for carrying out the inventive method.

Accordingly, the present invention, according to one aspect thereof, provides a method of achieving and maintaining sterility of a surface, the method comprising steps of: communicating steam to the surface; utilizing the steam to sterilize the surface; discontinuing communication of steam to the surface; communicating a sanitizing fluid to the surface at a temperature lower than the steam; and utilizing the sanitizing fluid to maintain sterility of the surface.

According to a more particular aspect of the present invention, it provides in addition to the above, a method wherein the step of communicating sanitizing fluid to the surface includes the step of communicating the sanitizing fluid to the surface at a temperature that is substantially ambient temperature.

Yet another aspect of the present invention provides, an aseptic and adiabatic method of processing sterile food product while also preventing heat flow to and overcooking of the food product due to proximity of the food product to sterilizing steam, comprising steps of: initially communicating a steam flow to physical surfaces to which the food product will be exposed; utilizing the steam flow to sterilize these surfaces; stopping the steam flow; transitioning a sterilized surface between exposure to the food product and exposure to ambient, following each exposure of the surface to ambient, exposing the surface to a sanitizing fluid; and maintaining this sanitizing fluid substantially at ambient temperature.

In order to provide apparatus for carrying out a method of the present invention, the invention also provides food processing apparatus comprising: a filling head having a filling tube with a food product inflow port, and an outflow nozzle adapted for communication of food product from the filling tube into a food package; the food package having a fitting adapted for sealing interface with the nozzle and providing a flow path for flow of food product to the package; a sterile chamber adapted to surround the nozzle and fitting, the sterile chamber reciprocating along the filling tube so that an external surface portion of the filling tube is alternatingly reciprocated relative to the sterile chamber and ambient; a steam trace structure surrounding the external surface portion of the filling tube; and steam source means adapted to selectively flow steam to the steam trace structure so that the steam is communicated to and sterilizes the external surface portion; alternative sanitizing fluid source means for selectively flowing sanitizing fluid substantially at ambient temperature to the steam trace structure for communication to the external surface portion to maintain sterility of this surface portion.

Other objects, features, and advantages of the present invention will be apparent to those skilled in the art from a consideration of the following detailed description of a preferred exemplary embodiment thereof taken in conjunction with the associated figures which will first be described briefly.

### BRIEF DESCRIPTION OF THE DRAWING FIGURES

FIG. 1; depicts serial processing of food packages at a filling machine (which is only fragmentarily shown), with one package shown preparatory to filling with food product, another package shown during filling, and a third package shown subsequent to filling;

FIGS. 2 and 3, respectively, provide fragmentary cross sectional views of a filling head of the filling machine which is partially seen in FIG. 1, and which is used to aseptically fill liquid or semi-liquid food product into the packages seen in FIG. 1;

FIG. 3a provides a greatly enlarged view of a portion of FIG. 3; and

FIG. 4 provides a schematic illustration of a portion of the filling machine seen in FIGS. 1-3, and illustrates alternative fluid flow paths providing for sterilization of portions of the filling machine using culinary steam at elevated temperature and pressure, and for maintenance of sterility of these portions of the machine using sanitizing fluid at substantially ambient temperature and sub-ambient pressure.

### DETAILED DESCRIPTION OF EXEMPLARY PREFERRED EMBODIMENTS OF THE INVENTION

While the present invention may be embodied in many different forms, disclosed herein is one specific exemplary embodiment that illustrates and explains the principles of the invention. In conjunction with the description of this embodiment, a method of carrying out the invention is described. It should be emphasized that the present invention is not limited to the specific embodiment illustrated.

An overview:

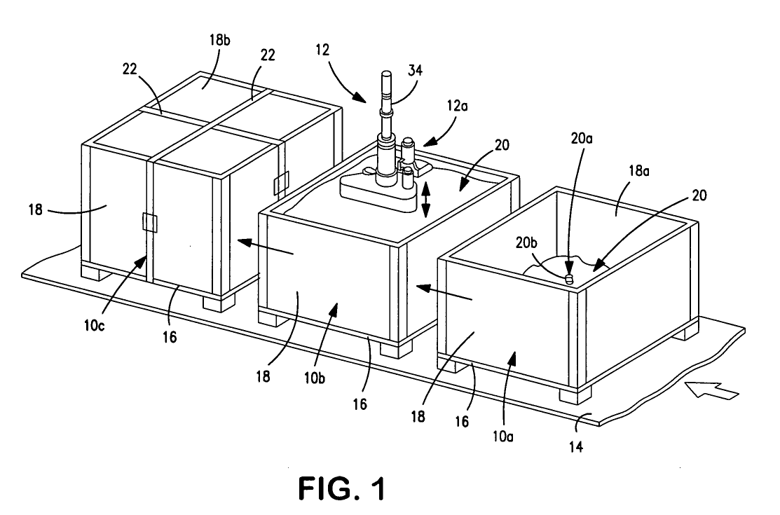

Referring first to FIG. 1, successive bag-in-box type food packages 10 are filled serially with liquid or semi-liquid (i.e., paste-like) food product. The packages 10 are filled by using a filling machine, generally indicated with the numeral 12. Only a fragmentary part of the filling machine 12 is illustrated in FIG. 1. The packages 10 are movable (as is indicated by movement arrows on FIG. 1) along a conveyor (indicated with numeral 14) in order to bring each package 10 successively into registry with a filling head portion 12a of machine 12. Each of the food packages 10 includes a pallet portion 16 resting on the movable conveyor 14, and a rigid crate portion 18 carried on the pallet portion 16. The crate portion 18 defines a cavity 18a, and includes a removable lid 18b. Within the cavity 18a of each crate 18 is received a flexible bag 29, and this bag is protected within the crate by the rigid and durable pallet, side walls, and lid of the crate 18. The bag portion 20 includes a fitting 20a (best seen within crate 10a) closed by a removable cap 20b. The fitting 20a provides access to the interior of the bag 20 when the cap 20b is removed from this fitting. The foregoing description of the food packages 10 will be familiar to those ordinarily skilled in the pertinent arts, and will be recognized as a bag-in-box or bag-in-crate packaging system.

Although those ordinarily skilled in the pertinent arts will be familiar with the generalities of the packages 10 and of conventional filling machines for such packages, in order to briefly explain this serial filling process in greater detail, it is to be noted that package 10a is in a condition and position preparatory to its filling with food product using the machine 12. That is, package 10a includes a bag 20, which is empty and capped. This bag will have been sterilized subsequent to its manufacture so that the interior of this bag remains sterile. Of course, the outside surfaces of the bags 20 are exposed to ambient conditions and to ambient air, and are not sterile. The crate lid 18a of this package has been removed preparatory to registry of this package with the filling head 12a of filling machine 12. Thus, the lid 18b of package 10a is not shown in FIG. 1.

Food package 10b (also having had its lid removed) has been moved from the position of crate 10a and into registry with the filling head 12a of filling machine 12, has already had the bag 20 engaged with the filling head 12a, which has uncapped this bag in order to fill food product into the bag. That is, as FIG. 1 illustrates, the package 10b is receiving sterile liquid or semi-liquid food product at substantially ambient temperature via the filling head 12a, which is in engagement with the uncapped fitting 20a (not visible in FIG. 1). Finally, food package 10c has been filled with food product, the fitting 20a has been resealed by replacement of cap 20b, and the lid 18b had been replaced on the crate portion 18, and is held in place by packaging bands 22. These packaging bands 22, which may be metal or polymer, for example, encircle both the pallet portion 16 and crate portion 18 including lid 18b. After its filling, the package 10c has been moved along conveyor 14 out of registry with the filling head 12a in order to allow replacement of the lid 18b and securing of the package with bands 22.

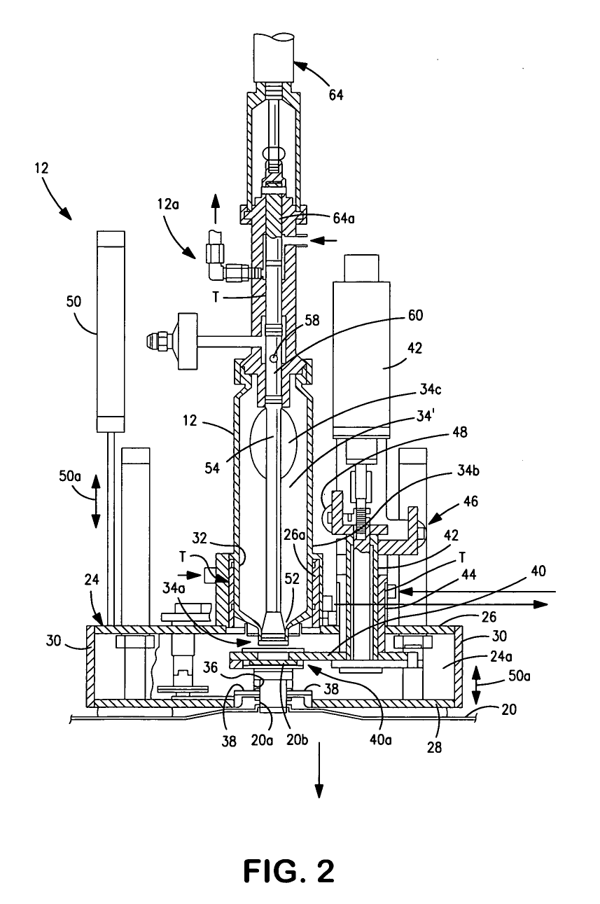

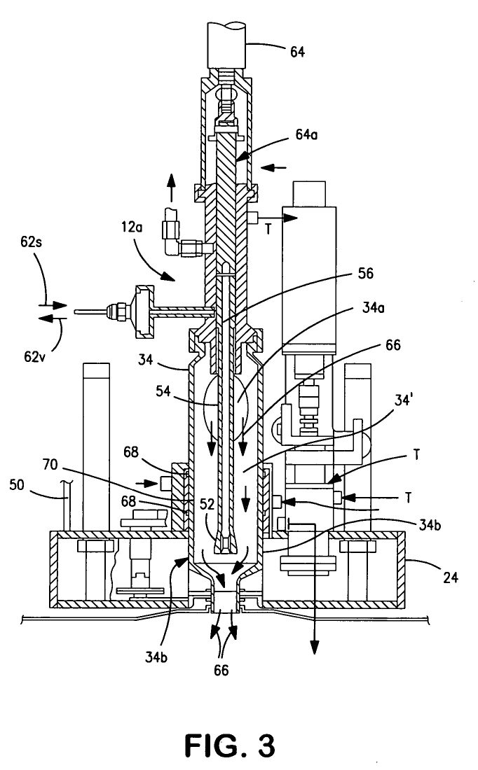

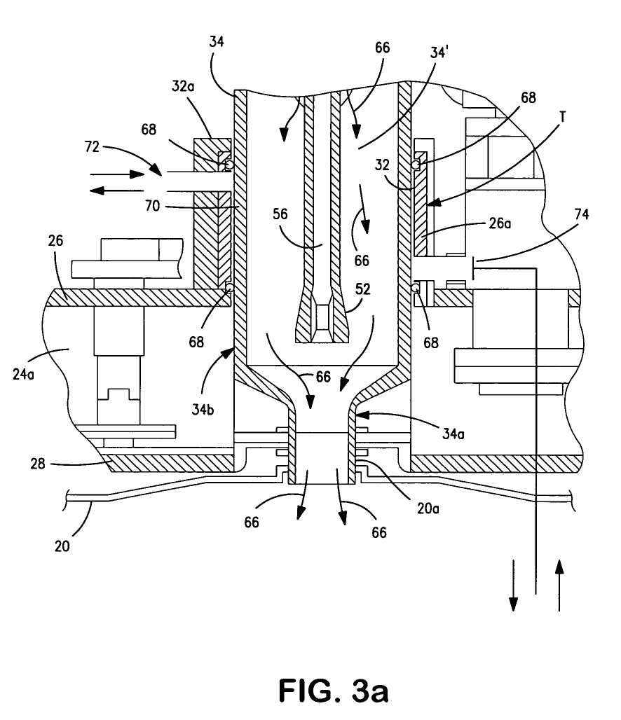

Turning now to FIGS. 2 and 3, these Figures show the filling head 12a of machine 12 in preparation for filling of bag 20 (i.e., FIG. 2), and during filling of a bag 20 (i.e., FIG. 3). That is, in FIG. 2 it will be seen that the bag 20 is still capped. Both of these Figures illustrate steps in the processing (i.e., filling) of packages 10, which steps take place while the package 10 and the bag 20 within this package are in alignment with machine 12 as is seen in FIG. 1 at the position of package 10b.

FIG. 2 shows that the filling head 12 includes a vertically reciprocable chamber structure 24. This chamber structure 24 is defined cooperatively by a top plate 26 and by a bottom plate 28. The plates 26 and 28 are spaced apart and cooperatively enclose a sterile or sanitized volume, as will be further explained. Vertically extending sidewalls, generally indicated with numeral 30, extend between and sealingly join with both the top plate 26 and bottom plate 28 to enclose a sterile or sanitized volume 24a within the chamber structure 24. In considering sterile chamber structure 24, it will be understood that the outside surfaces of this chamber (i.e., outside surfaces of plates 26, 28, and walls 30) are exposed to ambient (i.e., to ambient air and conditions present in the ambient environment surrounding the filling machine 12). Thus, the outside surfaces of sterile chamber structure 24 are exposed to ambient microbes, are not sterile, and only the inner volume 24a can properly be referred to as “sterile or sanitized”.

The top plate 26 includes an upstanding tubular portion 26a which defines an elongate bore 32 through which slidably passes a stationary filling tube 34 of the filling machine 12. That is, the chamber structure 24 is able to reciprocate vertically through a selected distance along the filling tube 34. As will be further explained, the bore 32 is formed to include plural steps and to include a bore portion defining a selected radial clearance with an outer surface portion of the filling tube 34. The filling tube 34 conducts sterile food product in liquid or semi-liquid condition and at substantially ambient temperature to the bag 20 via a nozzle portion 34a of this filling tube, as will be further explained. Aligning with the filling tube 34, the bottom plate 28 defines an aperture 36 which is sized to receive the closed and capped fitting 20a (i.e., with cap 20b in place on the fitting 20a) of the bag 20. In order to uncap the fitting 20a and allow engagement of the filling tube 34 with this fitting, arranged within the chamber 24 at the aperture 36 are both a pair of chucking jaws 38 and a capping arm 40. The chucking jaws 38 are carried on the bottom plate 28 and are engageable with the fitting 20a to hold this fitting securely. The capping arm 40 carries a set of capping jaws 40a which are engageable with the cap 20b. An actuator 42 located outside of the chamber 24 is effective to forcefully raise and lower the capping arm 40 relative to the chamber structure 24 by movement of a sleeve 42a within the opening 44a of an axially elongate guide 44 carried on the chamber structure 24. That is, the actuator 42 and sleeve 42a are stationary, while the chamber 24 and guide 44 reciprocate vertically relative to the actuator 42 and sleeve 42a.

Another actuator 46 carried on and movable with the chamber 24 is effective to selectively pivot the capping arm 40 in a plane perpendicular to the plane of FIG. 2 so that the jaws 40a at the distal end portion of capping arm 40 may be moved between a first position in alignment with the aperture 36 (as is seen in FIG. 2) and a second position (not seen in the Figures) in which the jaws 40a and distal portion of capping arm 40 are clear of the aperture 36 (such a pivotal positioning of capping arm 40 out of alignment with aperture 36 being seen in FIG. 3).

Yet another actuator (indicated by arrowed lead line 48, and which is generally located behind the actuator 42 in the views of FIGS. 2 and 3) is effective to selectively open and close the capping jaws 40a so that the cap 20b may be selectively retained in and released from these jaws at the distal end portion of capping arm 40.

As is seen in FIG. 2, by selective actuation of the actuators 42, 46, and 48, the fitting 20a may be grasped in chucking jaws 38, and the cap 20b is grasped in capping jaws 40a, after which the capping arm 40 is raised vertically relative to chamber 24. This raising of the capping arm 40 relative to the chamber structure 24 and fitting 20a forcefully removes the cap 20b from fitting 20a. The removed cap 20b is retained in capping jaws 40a adjacent the distal end of capping arm 40 while the capping arm 40 is pivoted to its second position with its distal end portion out of alignment with the aperture 36.

Subsequently, a pair of actuators 50 (only one of which is seen in FIG. 2) selectively raise (and later also selectively lower) the chamber 24 relative to the filling tube 34 (as is indicated by double-headed arrows 50a), carrying along the fitting 20a and the upper portion of the bag 20, to the position seen in FIG. 3. This vertically upward movement of the chamber structure 24 engages the nozzle portion 34a of the filling tube 34 into the fitting 20a preparatory to flowing of food product into the bag 20. Thus, each serial filling operation for a bag 20 at the filling head 12a commences in this way. The steps in a single filling operation are subsequently described.

As is seen in FIG. 3, the actions described above bring the nozzle 34a of filling tube 34 into engagement with the uncapped fitting 20a of bag 20. However, a valve member 52 disposed within the filling tube 34 will still be in the position seen in FIG. 2, closing the nozzle 34a so that no food product can yet flow from the filing tube 34 into the bag 20. As is also seen in FIG. 3, the valve member 52 is carried at the lower end of an elongate tubular stem 54. The filing tube 34, valve member 52, and stem 54 cooperate to define a chamber 34′, into which communicates an opening 34c, as will be further explained. Within the valve member 52 and stem 54 is defined an elongate passage 56 (best seen in FIG. 3). A radial passage 58 (best seen in FIG. 2) communicates the elongate passage 56 to an annular chamber 60 surrounding a portion of the stem 54. The chamber 60 is selectively communicated (as is indicated by the arrows 62S and 62V on FIG. 3) either to a source of culinary steam or to a source of vacuum.

When the valve 52 is opened by operation of an actuator 64 effectively connected to the stem 54, as is seen in FIG. 3, liquid or semi-liquid food product is allowed to flow from filing tube 34 into the bag 20 via nozzle 34a and fitting 20a. Arrows 66 seen in FIG. 3 represent this flow of food product. The food product flows into the filling tube 34 via the opening 34c, which communicates the food product from a source of the food product (i.e., from a pipeline, for example).

After the bag 20 has received a selected volume or weight of the food product from filing tube 34, the valve 52 is again moved by actuator 64 to the position seen in FIG. 2, cutting off the flow of food product. At this time in the sequence of processing steps or events, the bag 20 may be closed as is described below. That is, after filling of bag 20 the chamber 24 is lowered once again to the position seen in FIG. 2, and the cap 20b is again brought by capping arm 40 and capping jaws 40a into alignment with the fitting 20a. The capping arm 40 is then lowered forcefully to the position seen in FIG. 2 (which forces the cap 20b once again onto the fitting 20a). Next, the capping jaws 40a are then opened to release the cap 20b on the fitting 20a. Next, the chucking jaws 38 are released, freeing the fitting 20a from the filling head 12a.

Returning to consideration of FIG. 1, the container 10b is shown substantially at the completion of a filling cycle (i.e., with the bag 20 having received the measured portion of food product), but with the fitting 20a yet to be released from filling head 12a. However, once the fitting 20a is released from filling head 12a by opening of chucking jaws 38, the fitting 20a and bag 20 may be separated form the filling head 12a, and the crate 18 is moved along conveyor 14 so that lid 18b may then be placed on the crate 18 to be secured by bands 22, as is seen in FIG. 1 at 10c.

Plural Sterilizing Zones

In view of the above, it is to be appreciated that each of the filling tube 34, actuator sleeve 42, and actuator 64 (i.e., at a stem 64a) has a surface portion that reciprocates or rotates (or both) relative to the chamber structure 24 (and relative to the sterile or sanitized volume 24a) with each filling cycle of the filling machine 12. For example, each time the chamber 24 reciprocates upwardly and then downwardly along the filling tube 34 near the beginning and near the end of a filling cycle, a surface portion 34b of the filling tube 34 moves into and out of the chamber 24. Stated differently, these surface portions reciprocate or move toward and away from the sterile volume 24a, moving repeatedly back and forth relative to the ambient. For example, further considering the filling tube 34 at surface portion 34b seen in FIGS. 2 and 3, it will be appreciated that this surface portion reciprocates relative to the chamber structure 24 through a certain distance with each filling cycle of the filling machine 12 as described above. The surface portion 34b reciprocates between a position that is relatively close to the volume 24a, and a position that is more spaced from this volume, and in which port of this surface portion is in the ambient (e.g., compare the position of this surface portion 34b between FIGS. 2 and 3). Considered topologically, the surface portion 34b of filling tube 34 extends or communicates between ambient and the chamber 24a. As a result, by various transfer mechanisms (for example by a wiping process or by a process of successive transference), it is to be understood and will be appreciated that microbes could be transported along the surface portion 34b, and along other such reciprocating surface portions of the actuator sleeve 42, and actuator 64, between ambient and the sterile volume 24a. Alternatively, a surface portion may simply rotate, which still could have the effect of-allowing microbes to transfer from the ambient. If this transportation of microbes from ambient into the sterile volume 24a were allowed to take place, then the cleanliness of volume 24a would be lost.

In order to prevent this transportation of microbes along relatively reciprocating or rotating surfaces of the machine 12, each of these surfaces is provided with a trace (or gland) structure, each generally indicated with the character “T” on FIGS. 2 and 3. So far as viable microbes are concerned, these traces “T” interrupt or break the topological communication of the particular surfaces between ambient and the sterile conditions that are desired to be maintained for the food product being filled into the contains 10. Viable microbes simply cannot traverse a trace structure “T”.

In general, each of these trace or gland structures consists of a pair of axially spaced apart seals, which most desirably sealingly and movably contact the particular reciprocating or rotating surface. Cooperatively, these seals define an axially extending annular chamber surrounding the reciprocating or rotating surface portion. By “axially extending” is meant that the annular trace chamber extends along the relatively reciprocating or rotating surface and is elongate in the direction of reciprocation, or has a selected axial length in the case of a trace structure intended to seal a relatively rotating surface. Into these trace chambers “T” the filling machine 12 provides initially for culinary steam to selectively flow at a selected pressure and temperature. The culinary steam is initially effective to sterilize the surfaces at the traces “T” so that these trace surfaces are initially free of microbes. That is, initial or preparatory sterility of these surfaces is obtained or achieved by use of culinary steam flow. Such culinary steam flow at the traces is not desirable to maintain during food filling operations of the machine 12, however, because the steam is a source of heat which will transfer to the food product. Accordingly, further precautions will be taken to insure that microbes cannot be transported along these trace surfaces into the product in chamber 56 during operation of the filing head 12a.

Considering the surface portion 34b of filling tube 34 as an example once again, and viewing now particularly FIG. 3a, it is seen that the tubular portion 26a above top plate 26 carries a pair of axially spaced apart seal members or seals 68 contacting the surface 34b and cooperatively bounding an annular axially extending chamber 70 extending along the surface 34b. That is, the chamber 70 is defined by a selected radial clearance between the surface portion 34b and the bore of the tubular member 26a axially between these seal members 68.

However, it is to be appreciated that although the machine 12 is initially operated in a preparatory mode utilizing culinary steam supplied to the trace surfaces 34b, 42, and 64a to initially achieve sterility of the trace surfaces (i.e., such as surface 34b), and that heat flow from this culinary steam to the filling machine 12 (and to the food product) would present the same problems that are conventionally encountered, such steam flow is merely preparatory and is temporary according to the present invention. Further, while those ordinarily skilled in the pertinent arts will appreciate that non-adiabatic processing conditions (i.e., with heat flow from culinary steam to the food product) could result in exposure of the food product to over-cooking, and to deterioration because of time/temperature exposure factors, this present invention utilized adiabatic processing so that the food product is not heated in the filling machine 12. So, the conventional problem of heating and time/temperature exposure for the food product is avoided and solved by the present invention.

Initial Sterilization Using Culinary Steam

As will be seen, the filling machine 12 provides for initial sterilization of the trace surfaces “T” using culinary steam (i.e., steam at elevated temperature and pressure), in order to achieve sterility of the surfaces, after which a sanitizing fluid at substantially ambient temperature and at a sub-ambient pressure (i.e., partial vacuum) flows through the traces. This flow of sterility-maintaining sanitizing fluid at ambient temperature and at partial vacuum pressure is effective to maintain sterility of the trace surfaces (i.e., despite the movement of these surfaces relative to ambient). Further, in this mode of operation, substantially adiabatic conditions (i.e., without the gain or loss of heat) are maintained for the food product filled into packages 10 through machine 12. Also, because of the sub-ambient (partial vacuum) pressure maintained for the sterility-maintaining sanitizing fluid as it flows through the traces “T” any transference of fluid or particles (including microbes) between the ambient and a trace volume (or between the chamber 24a and a trace structure “T”) can only be in a direction toward the trace structure. Thus, no fluid or particles can travel from ambient to the sterile chamber via the trace structures.

Returning to consideration of FIG. 3a, it is seen that the trace structure includes an upper connection 72 communicating via the annular space 70 with a lower connection 74. A similar construction and connections are employed at each of the traces “T” so that description of the trace structure at surface 34b will suffice to describe each of them. In brief, during an initial preparatory steam-sanitizing mode, culinary steam flows from connection 70 through the annular space 70 (sanitizing the surface portion 34b) and from the connection 74, as is indicated by the arrows on this Figure. Any steam which condenses to water in the trace “T34” drains from the lower connection 74. On the other hand, after this initial steam-sanitizing mode, the machine 12 operates in a “adiabatic filling mode” in which steam is not employed at the traces “T”. During this adiabatic filling mode, a sanitizing fluid is drawn by partial vacuum from connection 74 upwardly through the trace “T” (i.e., through the annular space 70) and to the connection 72. This flow is effected by communicating the connection 72 to a source of partial vacuum, and by communicating the connection 74 with a source of sanitizing fluid. It will be noted viewing FIG. 3a that the direction of flow of the sterilizing fluid at ambient temperature and at a partial vacuum pressure is opposite to the direction of flow for the sterilizing steam flow.

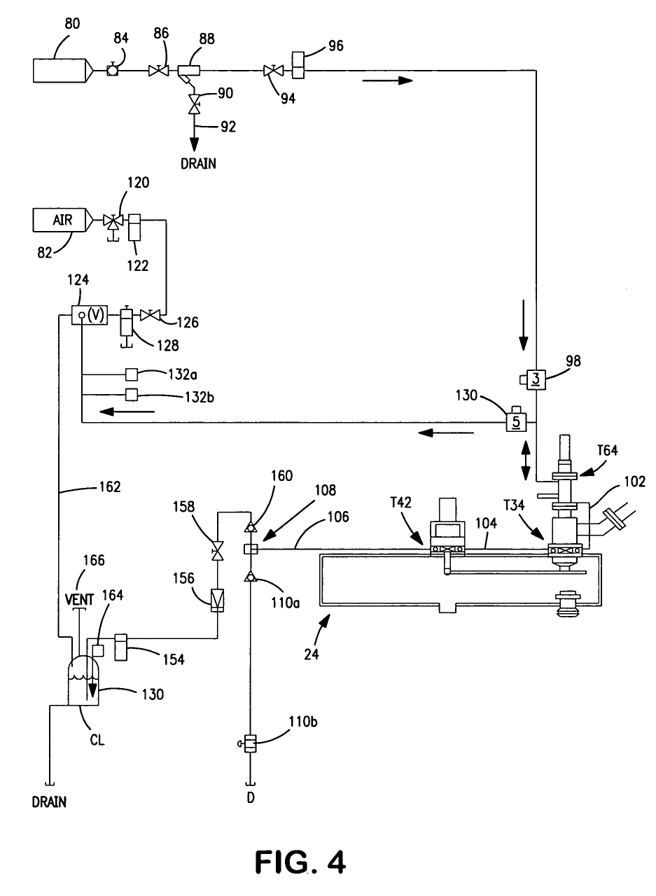

Further, turning now to FIG. 4, it is seen that the machine 12 provides for culinary steam to be received at 80 and for pressurized air to be received at 82. The culinary steam flows via a regulator 84 (which controls the pressure of this steam), to a control valve 86, and through a coarse filter 88. A valve 90 provides for selective purging of condensate (as is indicated by arrow 92) to a drain (indicated with the label “drain”). An additional valve 94 allows culinary steam to flow via a fme filter 96 to a valve 98 and to an upper one of the trace surfaces “T” (indicated on FIG. 4 with the arrowed character “T64”). In this preferred embodiment, the upper one of the trace surfaces “T” is the at the trace surface 64a at stem 64, recalling FIGS. 2 and 3. Comparing the diagrammatic illustration of FIG. 4 with the earlier illustrations of FIGS. 1-3a, it is seen that the arrangement of the filing head 24 has been rearranged for clarity of illustration.

During the initial sterilization, steam from the trace surface at stem 64a flows via a conduit 102 to the connection 72 and the trace at filling tube 34 (i.e., as is illustrated in FIG. 3a). The trace structure at filling tube 34 is indicated on FIG. 4 with the arrowed character “T34”. From the trace “T” at filing tube 34, a conduit 104 communicates from the connection 74 (recalling the illustration of FIG. 3a) to the trace surface at actuator 42. Again, the trace structure at actuator 42 is indicated with the arrowed character “T42” on FIG. 4. Those ordinarily skilled in the pertinent arts will recognize that the description of this particularly preferred embodiment of the invention is not limiting with respect to the particular order of steam flow through the several traces of the filling machine 12. Finally, as is seen on FIG. 4 at numeral 106, a conduit flows steam from the trace at actuator 42 to a tee, indicated at 108. From the tee 108, a check valve 110a and control valve 110b controllably allow steam flow to drain “D”.

In view of the above, it is easily understood that in preparation to the starting of filling operations of the machine 12, during the initial steam-sterilizing mode, the trace surfaces “T” at each of the valve filling tube 34, actuator sleeve 42, and valve stem 64a (indicated with arrowed reference numerals T34, T42, and T64, viewing FIG. 4) are sterilized using culinary steam simply by the selective opening of valves 86, 94, 98 and 110b.

Adiabatic Maintenance of Sterility Using Sanitizing Fluid at Ambient Temperature and Partial Vacuum

Returning now to further consideration of FIG. 4, it is seen that from the pressurized air supply 82, a valve 120 and filter 122 provide for flow of pressurized air to a vacuum pump 124. An additional valve 126 and filter 128 may also be provided. According to this particularly preferred exemplary embodiment, the vacuum pump 124 is of an ejector or aspirator type. However, the invention is not so limited. Fluid flow under partial vacuum to the pump 124 is drawn from the upper extent of a tank 130. Again, those ordinarily skilled will appreciate that the vacuum pump 124 need not be air powered, but that any suitable source of partial vacuum will serve. Also, in this preferred embodiment, the tank 130 holds a supply of strong chlorine solution, indicated with the character “CL” on FIG. 4. This strong chlorine solution serves as an ambient-temperature sterilant for the trace structures T34, T42, and T64 of the filling machine 12. However, any sufficiently active sterilant may be employed in this use. For example, perhaps a bromine solution would be found suitable. The sterilant need not be liquid, however. That is, an active oxidizing sterilant such as a sterile gas mixture perhaps including ozone, for example, may be provided as a sterilant effective at ambient temperature.

According to the illustrated preferred embodiment, a pair of vacuum level sensors 132a and 132b are also provided. These vacuum level sensors respectively provide output signals (indicated with arrows on FIG. 4) indicative of either a too low or too high a partial vacuum level at the pump 124. Generally, a too low vacuum level will be indicative of one or more leaking seals at the trace structures T34, T42, or T64 (recalling the seals 68 at trace structure T34 illustrated in FIG. 3a). On the other hand, a too high vacuum level will generally be indicative of a partially clogged fluid flow passage (i.e., for the ambient-temperature sterilant) at one of the trace structures. Accordingly, the filing machine 12 is provided with a vacuum level monitoring function provided by the two vacuum level sensors 132a and 132b, which monitors the continuing proper functioning of the ambient-temperature sterilizing operation at the traces T34, T42, and T64.

Importantly, in order to virtually eliminate heat input to chamber 24a (and to the food product piping and food product therein) which would otherwise result if culinary steam were employed to maintain sterile or sanitary conditions during packaging of food product with filling machine 12, a valve 150 may be opened (i.e., valves 98 and 150 are to open in mutual exclusivity to one another) to apply vacuum from ejector 124 to the trace surfaces T34, T42, and T64. Recalling from the explanation above the connection of the trace surfaces “T” , it is recalled that these surfaces are connected in the steam flow sequence T64, T34, and T42. Vacuum communicates along these surfaces in this same order when valve 98 is closed and valve 150 is opened, and vacuum communicates to tee 108. However, the check valve 110a (as well as optional closing of the valve 110b) prevents ambient air from being drawn in via the condensate drain outlet “D”.

Consequently, chlorine solution “CL” of selectively controlled strength and at substantially ambient temperature from the chlorine solution suction tank 130 is drawn via a filter 154, flow indicator 156, valve 158 and check valve 160 to the tee 108. From the tee 108 this chlorine solution flows in the opposite direction (and in the opposite sequence of contact with trace surfaces “T”) to that of the flow of culinary steam described above.

Importantly, this flow of sanitizing chlorine solution is at a sub-ambient (partial vacuum) pressure. Consequently, any leakage that occurs at the trace seals (i.e., the seals defining the bounds of the traces at surfaces 34, 42, and 64—at seals 68, for example recalling FIG. 3a) will result only in ingestion of either ambient air into the trace volume and the chlorine solution therein, or will result in the ingestion of steam vapor or sterile air from the sterile chamber 24a into the trace volume (the chamber 24a generally being maintained at a slight supra-ambient pressure). In all cases, no material will flow out of the trace volumes into the ambient or into the chamber 24a. This is the case because the trace volumes are all at a partial vacuum pressure. The results are that sterility of the portions of the trace surfaces (and food product piping) which do reciprocate in and out of the sterile chamber 24a are maintained by the ambient temperature sanitizing fluid (in this case, chlorine solution of selected strength), and that no heat flow from culinary steam is experienced by the food product being processed through the filling machine 12.

As is seen on FIG. 4, the chlorine solution drawn through the traces T34, T42, and T64 by vacuum provided by the vacuum pump 124 is ejected by this ejector (along with air that has operated the ejector) via conduit 162 into chlorine suction tank 130. An analysis and correction device 164 provides for monitoring of the strength of this chlorine solution, and for adjustment of this solution strength so that the effectiveness of the sterilizing action provided by the chlorine solution as an ambient-temperature sanitizing fluid is maintained. A vent 166 provides for air to be vented from the tank 130.

Now, returning to a consideration of FIG. 3a, it will be recalled that the chamber 24a reciprocates vertically through a certain distance relative to the filling tube 34. Similarly, the seals 68 which define the vertical extent of the trace structure T34 (moving along the surface of filing tube 34) are spaced apart by a determined vertical dimension. In each instance of a trace structure according to this present invention being used on a surface which reciprocates (as opposed to a surface which merely rotates), it is desired that the determined separation distance of the seals 68 (i.e., the length of the trace structure) exceed at least slightly the certain reciprocation distance. In this way, the trace structure T according to this invention always has at least a small or slight portion of the relatively reciprocating surface which always remains inside of the trace structure (i.e., between the seals 68, for example) which does not move outside of the trace structure to be exposed to ambient, and thus is always isolated from ambient. Thus, in a topological sense, this isolated surface portion which always remains inside of the trace structure defines a demarcation between ambient and the sterile volume desired to be maintained by use of the present trace structures. This isolated surface portion is initially sterilized by use of culinary steam, and is maintained sterile by use of ambient-temperature sterilant during food packaging operations using the machine according to the present invention.

Those skilled in the art will further appreciate that the present invention may be embodied in other specific forms without departing from the spirit or central attributes of the invention. For example, a salient feature of the present invention is the maintenance of substantially adiabatic conditions for the food product, while also preventing microbes from the ambient from crossing into a sterile processing environment through which the food product passes. The sterile processing environment in the preferred embodiment is initially achieved by the use of culinary steam at high temperature and supra-ambient pressure. However, this need not be the case. For example, the sterile processing environment may initially be achieved by the use of intense ultraviolet light, or by exposure of the surfaces of the environment enclosure to a sanitizing agent which is sufficiently vigorous that sterility is definitely and quickly achieved. Thereafter, a flow of milder sanitizing fluid to the surface portions will suffice to prevent migration and transport of microbes from the ambient into the sterile environment along the reciprocating or moving surface portions. Because the foregoing description of the present invention discloses only a particularly preferred exemplary embodiment of the invention, it is to be understood that other variations are recognized as being within the scope of the present invention. And again, it will be appreciated that although the present traces “T” or steam glands are illustrated and described in a context producing relative reciprocating motion at the trace or steam gland, this need not be the case. In other words, relative rotational motion, or a combination of relative reciprocation and relative rotation, may be produced or experienced at the traces or steam glands. The nature of the relative motion at the trace or steam gland has no influence on the utility of the present invention, and this invention may be used at these types of trace or steam gland structures, as well as at others. Accordingly, the present invention is not limited to the particular embodiment, which has been described in detail herein. Rather, reference should be made to the appended claims to define the scope and content of the present invention.

I claim:

1. A method of achieving and maintaining sterility of a surface, said method comprising steps of:
communicating steam to the surface utilizing the steam to sterilize the surface;
discontinuing communication of steam to the surface;
communicating a sanitizing fluid to the surface at a temperature lower than said steam; and
utilizing said sanitizing fluid to maintain sterility of the surface.

2. The method of claim 1 wherein said step of communicating said sanitizing fluid to the surface includes the step of communicating the sanitizing fluid to the surface at a temperature that is substantially ambient temperature.

3. The method of claim 1 further including the step of employing an aqueous solution of chlorine as said sanitizing fluid.

4. The method of claim 1 further including the steps of reciprocating said surface between exposure to ambient and exposure to a sterile volume, and utilizing exposure of said surface to said sanitizing fluid to prevent transport of microbes on said surface from ambient to said sterile volume.

5. An aseptic and adiabatic method of processing sterile food product while also preventing heat flow to and overcooking of the food product due to proximity of the food product to sterilizing steam, said method comprising steps of:
initially communicating a steam flow to physical surfaces to which the food product will be exposed;
utilizing the steam flow to sterilize these surfaces;
stopping said steam flow;
transitioning a surface between exposure to the food product and exposure to ambient,
following each exposure of said surface to ambient, exposing the surface to a sanitizing fluid; and
maintaining said sanitizing fluid substantially at ambient temperature.

6. The method of claim 5 wherein said step of utilizing steam flow to sterilize the surfaces is conducted using steam at elevated temperature and at supra-ambient pressure.

7. The method of claim 5 wherein said step of exposing the surface to sanitizing fluid is conducted at substantially ambient temperature.

8. The method of claim 5 wherein said step of exposing the surface to sanitizing fluid is conducted at sub-ambient pressure.

9. Food processing apparatus comprising:
a filling head having a filling tube with a food product inflow port, and an outflow nozzle adapted for communication of food product from the filling tube into a food package;
said food package having a fitting adapted for sealing interface with said nozzle and providing a flow path for flow of food product to the package;
a sterile chamber adapted to surround said nozzle and said fitting, said sterile chamber reciprocating relative to said filling tube so that an external surface portion of said filling tube is alternatingly exposed to said sterile chamber and to ambient;
a sterilizing trace structure surrounding said external surface portion of said filling tube; and
steam source means adapted to selectively flow steam to said sterilizing trace structure so that said steam is communicated to and sterilizes said external surface portion;
an alternative source of sterility-maintaining fluid for selectively flowing sterilizing fluid substantially at ambient temperature to said sterilizing trace structure for communication to said external surface portion to maintain sterility of said surface portion.

10. The apparatus of claim 9 wherein said sterilizing trace structure includes a pair of seal elements spaced apart along said external surface portion, said pair of seal elements defining a chamber therebetween bounded by said external surface portion, and means for flowing culinary steam to and from said chamber.

11. A method of continuity breaking at ambient temperature so as to prevent movement of viable microbes along a topologically continuous surface, which surface moves between ambient and a sterile environment, thus maintaining the sterile environment; said method comprising steps of:
defining a portion of said surface intermediate of ambient and the sterile environment;
initially communicating steam to the surface portion for a limited time interval sufficient to establish sterility by heat sterilization;
discontinuing communication of steam to the surface portion;
allowing the surface portion to cool to ambient temperature;
communicating a sanitizing fluid to the surface portion substantially at ambient temperature and sub ambient pressure; and
utilizing said sanitizing fluid to maintain sterility of the surface portion.

12. The method of claim 11 further including the step of employing an aqueous solution of chlorine as said sanitizing fluid.

13. Aseptic filling apparatus for adiabatically serial filling of food product into plural containers, each of said plural containers having a spout with a removable cap, said apparatus comprising:
a filling head defining a sterile chamber; and said filling head engaging said spout, removing said cap, filling food product into said container, and replacing said cap all within said sterile chamber;
said filling head defining a pair of relatively reciprocating surfaces, one of which is exposed to both ambient and to said sterile chamber, said pair of relatively reciprocating surfaces moving relatively to one another in response to serial filling of containers;
a trace chamber in juxtaposition to said one reciprocating surface
a source of culinary steam flowable to said trace chamber to initially sterilize said one reciprocating surface while food product is not present at said filling head and is not exposed to heat from said cullinary steam; and
a source of ambient-temperature sterilizing fluid alternatively flowable to said trace chamber in exclusion of said cullinary steam;
whereby, said ambient-temperature sterilizing fluid is effective to maintain sterility of said one reciprocating surface during filling of food product into said plural containers and despite repeated reciprocations of said pair of reciprocating surfaces.
